(19) United States
(12) Patent Application Publication
(10) Pub. No.: US 2020/0311659 A1
(43) Pub. Date: Oct. 1, 2020

(54) INFORMATION PROCESSING APPARATUS, INFORMATION PROCESSING METHOD, AND PROGRAM

(71) Applicant: NEC CORPORATION, Tokyo (JP)

(72) Inventors: Yaeko YONEZAWA, Tokyo (JP); Kaito HORITA, Tokyo (JP); Akira YAJIMA, Tokyo (JP); Mizuto SEKINE, Tokyo (JP); Yoshinori EHARA, Kanagawa (JP)

(73) Assignee: NEC CORPORATION, Tokyo (JP)

(21) Appl. No.: 16/651,925

(22) PCT Filed: Aug. 3, 2018
(86) PCT No.: PCT/JP2018/029187

§ 371 Date: Mar. 27, 2020

(30) Foreign Application Priority Data
Sep. 29, 2017 (JP) 2017-191791

(51) Int. Cl. G06Q 10/08; G06T 7/70; A47F 5/00

(52) U.S. Cl. CPC G06Q 10/087; A47F 5/0068; G06T 7/70

(57) ABSTRACT

An information processing apparatus (10) includes a product information acquisition unit (110) that acquires the position of a product by analyzing an image in which the product and a shelf label are imaged, a shelf label information acquisition unit (120) that acquires the position of a shelf label by analyzing the image, a first determination unit (130) that determines consistency in a correspondence relation between the product and the shelf label on the basis of a relation between the acquired position of the product and the acquired position of the shelf label, and an output unit (140) that outputs a determination result of the consistency in the correspondence relation between the product and the shelf label.

### TECHNICAL FIELD

The present invention relates to a technology for analyzing a shelf allocation work in a store or the like.

### BACKGROUND ART

A shelf label describing information regarding a product, such as a product name and a price is disposed in the vicinity of the product displayed on a product shelf of a store. In a case where the shelf label is not correctly associated with the product, a problem in that a customer of the store erroneously recognizes the price and the like of the product may occur.

Patent Document 1 or Patent Document 2 discloses an example of a technology of checking whether or not a product on a product shelf is correctly associated with a shelf label. Patent Document 1 discloses a technology of preparing association information indicating a correspondence relation between product information and an electronic shelf label, in advance, and determining whether or not a correspondence relation between a product and an electronic shelf label, which is determined on the basis of the position of the product and the position of the electronic shelf label in an image, coincides with the correspondence relation in the association information. Patent Document 2 discloses a technology of determining whether or not an error is present in a relation between the number of types of products recognized from an image and the number of shelf labels or in a relation between the position of the product of each type recognized from the image and the position of the shelf label recognized from the image.

### RELATED DOCUMENT

### Patent Document

[Patent Document 1] International Publication No. WO2016/052379

[Patent Document 2] International Publication No. WO2016/052383

### SUMMARY OF THE INVENTION

### Technical Problem

In the above-described technology in Patent Document 1, for all products displayed on a product shelf, the correspondence relation between the product information and the electronic shelf label is required to be prepared in advance. Thus, it takes the effort and time. In the above-described technology in Patent Document 2, it is not possible to detect an error of a correspondence relation, in that the correspondence relation of the position or the number is correct, but product information described in the shelf label is incorrect.

The present invention has been made in view of the above problems. One object of the present invention is to provide a technology of easily determining whether or not a shelf label is correctly associated with a product on a product shelf of a store, with high accuracy.

### Solution to Problem

According to the present invention,

there is provided an information processing apparatus including

a product information acquisition unit that acquires a position of a product by analyzing an image in which the product and a shelf label are imaged,

a shelf label information acquisition unit that acquires a position of the shelf label by analyzing the image,

a first determination unit that determines consistency in a correspondence relation between the product and the shelf label on the basis of a relation between the acquired position of the product and the acquired position of the shelf label,

and an output unit that outputs a determination result of the consistency in the correspondence relation.

According to the present invention,

there is provided an information processing method executed by a computer, the method including:

acquiring a position of a product by analyzing an image in which the product and a shelf label are imaged,

acquiring a position of the shelf label by analyzing the image,

determining consistency in a correspondence relation between the product and the shelf label on the basis of a relation between the acquired position of the product and the acquired position of the shelf label,

and outputting a determination result of the consistency in the correspondence relation.

According to the present invention,

there is provided a program causing a computer to perform the information processing method.

### Advantageous Effects of Invention

According to the present invention, it is possible to easily determine whether or not a shelf label is correctly associated with a product on a product shelf of a store, with high accuracy.

### BRIEF DESCRIPTION OF THE DRAWINGS

The above-described and other objects, features and advantages will become more apparent from the preferred example embodiments described below and the accompanying drawings.

FIG. 1 is a block diagram conceptually illustrating a functional configuration of an information processing apparatus according to a first example embodiment.

FIG. 2 is a diagram illustrating a configuration of a computer that realizes the information processing apparatus.

FIG. 3 is a flowchart illustrating an operation example of the information processing apparatus according to a second example embodiment.

FIG. 4 is a diagram illustrating an example of an image to be processed.

FIG. 5 is a flowchart illustrating an operation example of an information processing apparatus according to a third example embodiment.

FIG. 6 is a block diagram illustrating a functional configuration of an information processing apparatus according to a fourth example embodiment.

FIG. 7 is a flowchart illustrating an example of an operation of the information processing apparatus according to the fourth example embodiment.

FIG. 8 is a flowchart illustrating another example of the operation of the information processing apparatus according to the fourth example embodiment.

### DESCRIPTION OF EMBODIMENTS

Hereinafter, example embodiments of the present invention will be described with reference to the drawings. In all the drawings, the similar components are denoted by the similar reference signs, and description thereof will not be repeated. Except for a case where a particular statement is made, in each block diagram, each block represents not a constituent component in a hardware unit, but a constituent component in a functional unit.

### First Example Embodiment

[Functional Configuration]

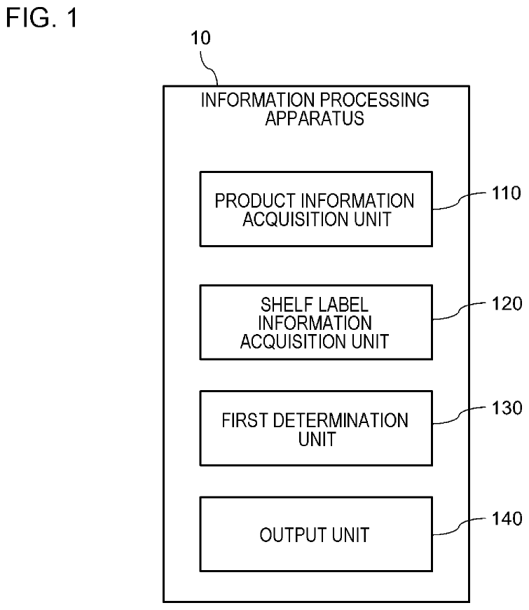

FIG. 1 is a block diagram conceptually illustrating a functional configuration of an information processing apparatus 10 according to a first example embodiment. As illustrated in FIG. 1, the information processing apparatus 10 in the present example embodiment includes a product information acquisition unit 110, a shelf label information acquisition unit 120, a first determination unit 130, and an output unit 140.

The product information acquisition unit 110 acquires the position of each product by analyzing an image (described as “an image to be processed” below) in which one or more products and one or more shelf labels are imaged. The product information acquisition unit 110 may further acquire product information associated with each product, by analyzing the image to be processed. The product information includes information (product identification information) for identifying the product. The shelf label information acquisition unit 120 acquires the position of each shelf label by analyzing the image to be processed. The shelf label information acquisition unit 120 may further acquire product information (shelf label-product information) described in each shelf label by analyzing the image to be processed. Here, the shelf label may be a shelf label made of an analog medium such as paper, or a so-called electronic shelf label made of an electronic medium. The first determination unit 130 determines consistency in a correspondence relation between the product and the shelf label on the basis of a relation between the position of the product which is acquired by the product information acquisition unit 110 and the position of the shelf label which is acquired by the shelf label information acquisition unit 120. In a case where the product information acquisition unit 110 further acquires product information associated with each product, and the shelf label information acquisition unit 120 further acquires shelf label-product information, the first determination unit 130 may further determine the consistency in the correspondence relation between the product and the shelf label on the basis of a relation between the product information acquired by the product information acquisition unit 110 and the shelf label-product information acquired by the shelf label information acquisition unit 120. The output unit 140 outputs a determination result for the consistency in the correspondence relation between the product and the shelf label.

[Hardware Configuration]

Each functional constituent unit of the information processing apparatus 10 may be realized by hardware (for example, hard-wired electronic circuit or the like) that implements each functional constituent unit, or may be realized by a combination of hardware and software (for example, combination of an electronic circuit and a program for controlling the electronic circuit). A case where each functional constituent unit of the information processing apparatus 10 is realized by a combination of hardware and software will be further described below.

Various computers are provided as a computer 1000. For example, the computer 1000 is a personal computer (PC), a server machine, a tablet terminal, or a smartphone. The computer 1000 may be a dedicated computer designed for realizing the information processing apparatus 10 or may be a general-purpose computer.

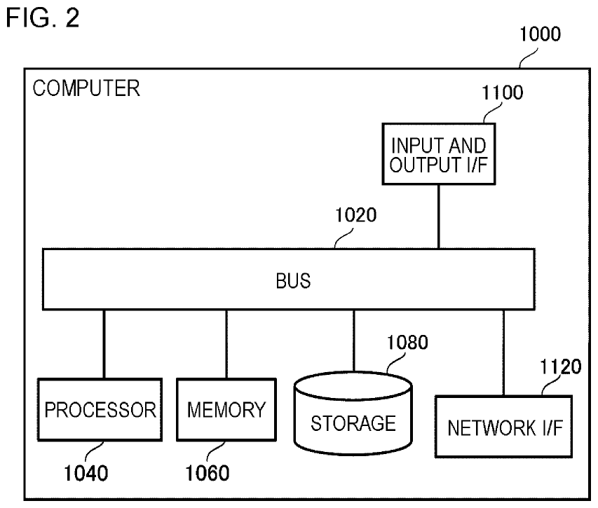

FIG. 2 is a diagram illustrating a configuration of the computer 1000 that realizes the information processing apparatus 10. The computer 1000 includes a bus 1020, a processor 1040, a memory 1060, a storage device 1080, an input and output interface 1100, and a network interface 1120. The bus 1020 is a data transmission path for causing the processor 1040, the memory 1060, the storage device 1080, the input and output interface 1100, and the network interface 1120 to transmit and receive data to and from each other. A method of connecting the processor 1040 and the like to each other is not limited to a bus connection. The processor 1040 is a processor realized by a central processing unit (CPU), a graphics processing unit (GPU), and the like. The memory 1060 is a main storage realized by a random access memory (RAM) and the like. The storage device 1080 is an auxiliary storage realized by a hard disk drive (HDD), a solid state drive (SSD), a memory card, a read only memory (ROM), or the like.

The input and output interface 1100 is an interface for connecting the computer 1000 and input and output devices to each other. For example, an input device such as a keyboard or an output device such as a display device is connected to the input and output interface 1100.

The network interface 1120 is an interface for connecting the computer 1000 to a network. The network is a local area network (LAN) or a wide area network (WAN), for example. A method of connecting the network interface 1120 to the network may be a wireless connection or a wired connection.

The storage device 1080 stores program modules for implementing the functions (product information acquisition unit 110, the shelf label information acquisition unit 120, the first determination unit 130, the output unit 140, and the like) of the information processing apparatus 10. The processor 1040 executes each program module to implement the function corresponding to the program module.

As described above, in the present example embodiment, the first determination unit 130 uses a relation between the position of a product and the position of a shelf label or uses the relation between the position of the product and the position of the shelf label and a relation between a product captured in the image and a product described in the shelf label captured in the image, when determining consistency in a correspondence relation between the product and the shelf label. With this configuration, it is possible to determine whether or not the product and the shelf label are correctly associated with each other, without performing association processing in advance. With this configuration, it is possible to determine whether or not the product and the shelf label are correctly associated with each other, with high accuracy.

### Second Example Embodiment

In the present example embodiment, the information processing apparatus 10 in the first example embodiment will be more specifically described.

[Functional Configuration and Hardware Configuration]

An information processing apparatus 10 in the present example embodiment has a functional configuration (for example, FIG. 1) and a hardware configuration (for example, FIG. 2), similar to the first example embodiment. In the present example embodiment, the information processing apparatus 10 acquires an image to be processed from an external apparatus connected through the input and output interface 1100 or the network interface 1120. Although not particularly limited, the external apparatus is a tablet terminal or a smartphone of a person in charge of a retail store or a person in charge of a manufacturer, a surveillance camera in a store, or the like. For example, the information processing apparatus 10 communicates with a tablet terminal, a smartphone, or the like of a person in charge of a retail store or a person in charge of a manufacturer, through the network interface 1120 to acquire the image to be processed.

[Operation Examples]

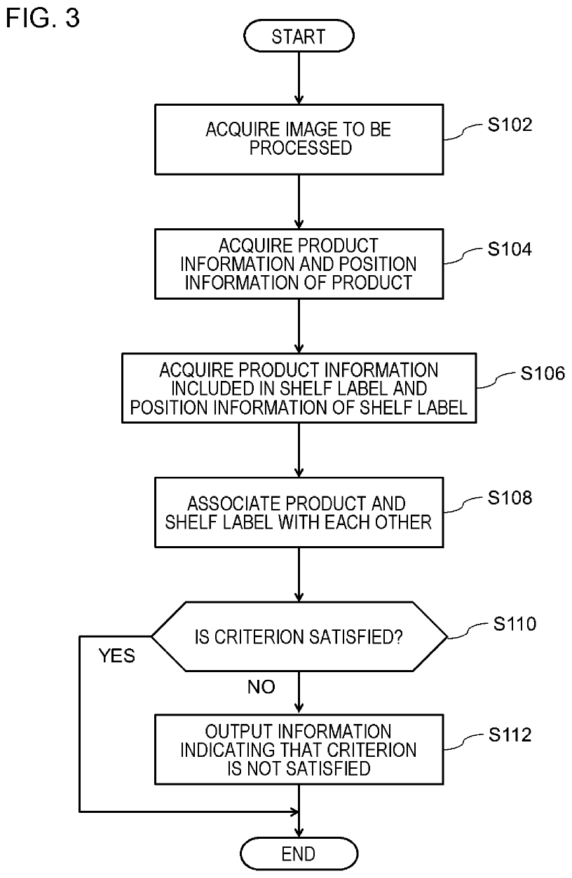

An operation example of the information processing apparatus 10 will be described with reference to FIG. 3. FIG. 3 is a flowchart illustrating the operation example of the information processing apparatus 10 according to the second example embodiment.

<First Operation Example>

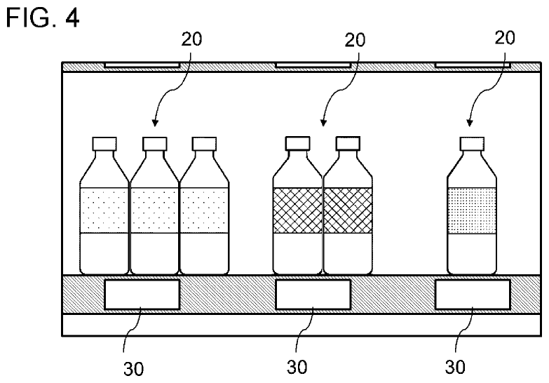

Firstly, the information processing apparatus 10 acquires an image to be processed (for example, FIG. 4) (S102). FIG. 4 is a diagram illustrating an example of the image to be processed. In the image to be processed illustrated in FIG. 4, the reference sign of 20 indicates products displayed on a product shelf. In the image to be processed illustrated in FIG. 4, the reference sign of 30 indicates a shelf label disposed on the product shelf. The image to be processed as illustrated in FIG. 4 is generated, for example, by a portable terminal such as a tablet terminal or a smartphone, or by a surveillance camera in a store. For example, a person in charge of a retail store or a person in charge of a manufacturer captures an image of a desired area of the product shelf with a camera function of a portable terminal, and thereby the image to be processed as illustrated in FIG. 4 is generated. For example, the information processing apparatus 10 may communicate with the tablet terminal or the smartphone of the person in charge of a retail store or the person in charge of a manufacturer, to acquire the image to be processed. In a case where the information processing apparatus 10 includes an image capturing function, the information processing apparatus 10 may generate the image to be processed. In a case where the image to be processed is stored in a storage apparatus (external server or the like) not illustrated, the information processing apparatus 10 may communicate with the storage apparatus to acquire the image to be processed.

The product information acquisition unit 110 analyzes the image to be processed and acquires product information of a product captured in the image to be processed and position information (described as “product position information” below) of the product (S104).

Specifically, the product information acquisition unit 110 analyzes the image to be processed, and thereby extracts an area (also described as “a product area” below) representing the product in the image to be processed. It should be noted that, the product information acquisition unit 110 may extract a product area using various known object recognition technologies. In a case where a plurality of products are captured in the image to be processed, the product information acquisition unit 110 extracts a product area of each product. The product information acquisition unit 110 analyzes the extracted product area and acquires product information of a product represented by the product area and position information of the product.

For example, the product information acquisition unit 110 may recognize a product represented by each product region, by performing pattern matching based on an image feature value extracted from each product region. In this case, a table in which the image feature value of each product and product information of each product are associated with each other is prepared in the memory 1060 or the storage device 1080. As an example, the product information regarding the product may include at least any of types of information such as the name (product name) of each product, an identifier (Japanese article number (JAN) code or the like) for identifying each product, the name (for example, brand name) of a group to which the product belongs, a product category to which the product belongs, a content (for example, 350 ml) of the product, the size of the product, and a standard price and a maker (manufacturer or sales maker) of each product. Here, the standard price means a standard price when the price of each product is determined at a store, for example, a suggested retail price or a set price of a product at a nearby store or another affiliated store, and the like. The standard price may information having a range (information indicating a price range). For example, information indicating a price range of each product may be stored in the memory 1060 and the like, and the product information acquisition unit 110 may read the information indicating the price range of the product. Information indicating a range for determining the price range may be stored in the memory 1060 and the like, and the product information acquisition unit 110 may compute, on the basis of the price of the product obtained on the basis of a result of image processing and information indicating the range, the price range of the product. It should be noted that, the range may be changed depending on the price of the product. The product information acquisition unit 110 may acquire a plurality of set prices for a product at the store or another affiliated store and determine the price range of the product by the highest price and the lowest price. The product information acquisition unit 110 determines an image feature value which is equal to or most similar to the image feature value extracted from the product area, among a plurality of image feature values stored in the table. The product information acquisition unit 110 acquires product information associated with the determined image feature value.

The product information acquisition unit 110 may acquire the position of the product on the product shelf, as the product position information. The position of the product may be represented, for example, by a combination of the position in a column direction (for example, the product is located in what row from the top row) and the position in a row direction (for example, the product is located in what column from the left-end column). Here, the known technology may be used for a technology of determining the position of each product from the image in which the product shelf is included. It should be noted that, in a case where the same type of products (products having the same product name) are disposed at a plurality of positions, the product information acquisition unit 110 is set to acquire a plurality of positions for one product. It should be noted that, a process of determining the position is not limited thereto. For example, the product information acquisition unit 110 may acquire coordinate values of the product area determined for each product, on the image to be processed as the product position information.

Here, a plurality of same products may be displayed in a horizontal direction. In such a case, the product information acquisition unit 110 determines an area (described as “a product group area” below) representing the adjacent same product and acquires coordinates of the product group area on the image to be processed, as the position information of one product. It should be noted that, the product information acquisition unit 110 may determine “the adjacent same product”, for example, on the basis of “whether or not image feature values extracted from the product areas are equal or similar to each other, or pieces of product information obtained using the image feature values are identical or similar to each other”. The product information acquisition unit 110 may obtain the number of products having the same product information, that is, the number of faces from the determined product group area.

It should be noted that, in the above description, the product information acquisition unit 110 acquires the coordinates of the product group area on the image to be processed, as the position information of one product. However, the configuration of the product information acquisition unit 110 is not limited thereto. For example, the product information acquisition unit 110 may acquire coordinates of each product included in the product group area, on the image to be processed.

Plural types of products (variation products) that are the same item but differ in some attributes (for example, the taste of the product or the color of the product) may be disposed to be adjacent to each other. In such a case, the product information acquisition unit 110 may recognize the plural types of products as products different from each other, or as the same products. In the latter case, for example, feature values of the plural types of products required to be recognized as the same products are stored in one record in the above table, in association with each other. The product information acquisition unit 110 may determine, for example, an area (product group area) representing a variation product group, by using the association. The product information acquisition unit 110 acquires the coordinates of the product group area on the image to be processed, as the position information of one product. The product information acquisition unit 110 may acquire the position information of each product among plural types of products differing in some attributes.

Similarly, the shelf label information acquisition unit 120 analyzes the image to be processed and acquires product information (described as “shelf label-product information” below) described in a shelf label captured in the image to be processed and position information (described as “shelf label position information” below) of the shelf label (S106).

Specifically, the shelf label information acquisition unit 120 analyzes the image to be processed, and thereby extracts an area (also described as “a shelf label area” below) representing the shelf label. In a case where a plurality of shelf labels are captured in the image to be processed, the shelf label information acquisition unit 120 extracts a shelf label area of each shelf label. The shelf label information acquisition unit 120 analyzes the extracted shelf label area and acquires product information described in a shelf label represented by the shelf label area and position information of the shelf label.

For example, the shelf label information acquisition unit 120 may acquire the product information (name of the product, description of the product, price of the product, and the like) described in the shelf label, by analyzing the shelf label area with an optical character recognition (OCR) technology or the like. The shelf label may include a barcode or a two-dimensional code (for example, a Japanese article number (JAN) code or a price look up (PLU) code) obtained by encoding identification information (product ID) for identifying each product. In this case, the shelf label information acquisition unit 120 may acquire encoded identification information as shelf label-product information, by analyzing an area in which the barcode or the two-dimensional code is captured. It should be noted that, in a case where the barcode or the two-dimensional code is a non-PLU code, the shelf label information acquisition unit 120 may further acquire the price of the product by analyzing the area in which the barcode or the two-dimensional code is captured. The shelf label information acquisition unit 120 may acquire coordinate values of the shelf label area determined for each shelf label, on the image to be processed as the shelf label position information.

The first determination unit 130 associates the product and the shelf label with each other on the basis of the product position information acquired by the product information acquisition unit 110 and the shelf label position information acquired by the shelf label information acquisition unit 120 (S108).

As an example, the first determination unit 130 may associate the product and the shelf label with each other as follows. Firstly, the first determination unit 130 determines a product located within a distance of a predetermined threshold value dₜₕ from a certain shelf label, on the basis of a distance computed using the product position information and the shelf label position information. It should be noted that, the predetermined threshold value dₜₕ is any value indicating an allowable range of a positional shift between the product and the shelf label and is stored in the memory 1060 and the like in advance. The first determination unit 130 associates the determined product with the shelf label. In a case where a plurality of products are present within the distance of the predetermined threshold value dₜₕ from a certain shelf label, the first determination unit 130 may associate the nearest product with the shelf label.

The first determination unit 130 determines whether or not the association between the product and the shelf label satisfies a criterion (S110). In other words, the first determination unit 130 determines consistency in a correspondence relation between the product and the shelf label. As an example, in a case where there is a product which is not associated with the shelf label (that is, in a case of lack of the shelf label), the first determination unit 130 determines that the criterion is not satisfied (consistency is not established). As another example, in a case where there is a shelf label which is not associated with the product (that is, in a case where the shelf label is in excess), the first determination unit 130 determines that the criterion is not satisfied (consistency is not established). As yet another example, in a case where a plurality of shelf labels having different shelf label-product information (plurality of shelf labels having different descriptions) are associated with one product, the first determination unit 130 determines that the criterion is not satisfied (consistency is not established). As still another example, in a case where a plurality of products having different types are associated with one shelf label, the first determination unit 130 determines that the criterion is not satisfied (consistency is not established). In a case where the association between a product and a shelf label does not correspond to any of the above-described examples in the process of S108, the first determination unit 130 determines that the criterion is satisfied (consistency is established, that is, the product and the shelf label are correctly associated with each other). It should be noted that, the operation of the first determination unit 130 is not limited to the above-described examples.

It should be noted that, the first determination unit 130 may further determine whether or not the product and the shelf label associated with each other has the same product information (that is, whether or not the product information described in the shelf label is incorrect), in the process illustrated in S110. In this case, in a case where the product and the shelf label associated with each other does not have the same product information, the first determination unit 130 determines that the criterion is not satisfied. In this case, the first determination unit 130 may detect that an incorrect shelf label is assigned to a certain product. As a specific example, the first determination unit 130 determines whether or not the product price included in the shelf label-product information acquired by the shelf label information acquisition unit 120 is in the price range of the standard price of the product, which is included in the product information acquired by the product information acquisition unit 110. For example, in a case where the product price included in the shelf label-product information largely deviates from the standard price (price range) included in the product information, the first determination unit 130 may determine that an incorrect shelf label is assigned to a certain product (consistency is not established). In this case, the first determination unit 130 may determine that an abnormal price is set for a certain product (consistency is not established).

In a case where the first determination unit 130 determines that the criterion is not satisfied (No in S110), the output unit 140 outputs information indicating details of the determination by the first determination unit 130, to a portable terminal held by a person in charge of a head office of the store or the person in charge of a manufacturer, or to a terminal installed in the store (S112). For example, the output unit 140 displays a screen on which a determination result (for example, correct association, lack of a shelf label, surplus of the shelf label, and an error of the product information described in the shelf label) of each combination of the product and the shelf label associated in the process of S108 is superimposed and displayed on the image to be processed, on a display of a terminal as an output destination. That is, the output unit 140 causes the determination result to be displayed on a providing unit such as a display in a form recognizable by a user.

<Second Operation Example>

S102 to S106 in a second operation example of the information processing apparatus 10 are similar to those in the first operation example. In the association based on the position information, which is described in S108 in the first operation example, the first determination unit 130 associates a product and a shelf label having the same product information, with each other. The first determination unit 130 determines whether or not the association between the product and the shelf label satisfies the criterion (S110). In other words, the first determination unit 130 determines consistency in a correspondence relation between the product and the shelf label. As an example, in a case where there is a product which is not associated with the shelf label (that is, in a case of lack of the shelf label), the first determination unit 130 determines that the criterion is not satisfied (consistency is not established). As another example, in a case where there is a shelf label which is not associated with the product (that is, in a case where the shelf label is in excess), the first determination unit 130 determines that the criterion is not satisfied (consistency is not established). As yet another example, in a case where a difference in position information between the product and the shelf label associated with each other is equal to or larger than a criterion (in a case where the position of the shelf label is shifted), the first determination unit 130 determines that the criterion is not satisfied (consistency is not established). In a case where the association between a product and a shelf label does not correspond to any of the above-described examples in the process of S108, the first determination unit 130 determines that the criterion is satisfied (consistency is established, that is, the product and the shelf label are correctly associated with each other). It should be noted that, the operation of the first determination unit 130 is not limited to the above-described examples.

In a case where the first determination unit 130 determines that the criterion is not satisfied (No in S110), the output unit 140 outputs information indicating details of the determination by the first determination unit 130, to a portable terminal held by a person in charge of a head office of the store or the person in charge of a manufacturer, or to a terminal installed in the store (S112). For example, the output unit 140 displays a screen on which a determination result (for example, correct association, lack of a shelf label, surplus of the shelf label, and a shift of the shelf label) of each combination of the product and the shelf label associated in the process of S108 is superimposed and is displayed on the image to be processed, on a display of a terminal as an output destination.

As described above, according to the present example embodiment, the information processing apparatus 10 determines the position of the product and determines the position of the shelf label, by image processing. In a case where the relation in position does not satisfy the criterion (for example, in a case where the product and the shelf label are spaced from each other at a distance which is equal to or more than a predetermined value), information indicating that the relation in position does not satisfy the criterion is output. Thus, it is possible to detect the error in the correspondence relation between a product and a shelf label with high accuracy.

### Third Example Embodiment

A functional configuration of an information processing apparatus 10 according to the present example embodiment is similar to the functional configuration of the information processing apparatus 10 according to the first example embodiment or the second example embodiment.

[Operation Examples]

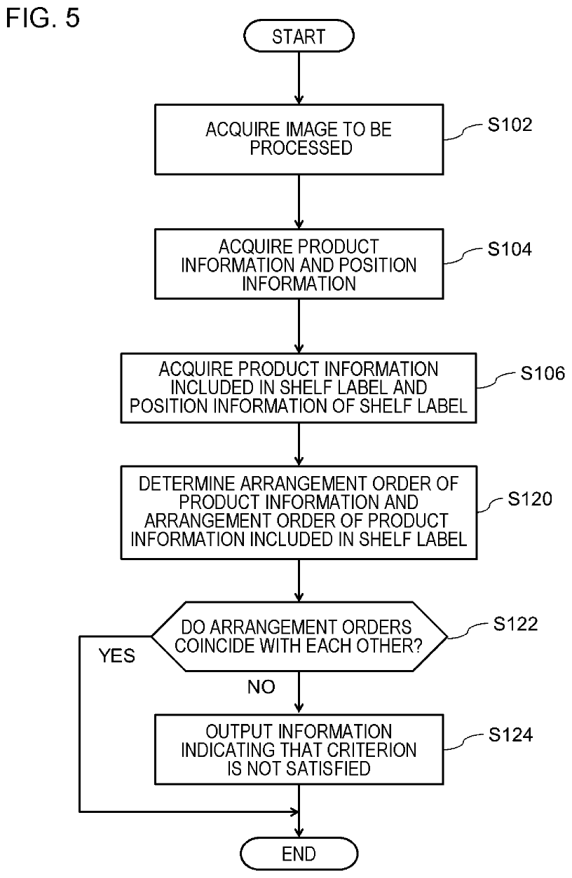

FIG. 5 is a flowchart illustrating an operation example of an information processing apparatus 10 according to the third example embodiment. Processes illustrated in S102 to S106 among processes illustrated in FIG. 5 are similar to the processes illustrated in FIG. 3. The first determination unit 130 determines an arrangement order of product information acquired by the product information acquisition unit 110 and an arrangement order of shelf label-product information acquired by the shelf label information acquisition unit 120 (S120). The first determination unit 130 determines whether or not the two arrangement orders coincide with each other (S122). Here, a case where the arrangement order of the product information does not coincide with the arrangement order of the shelf label-product information means at least any of a state where an order of the shelf label is correct, but an order of the product is incorrect, and a state where the order of the product is correct, but the order of the shelf label is incorrect. Thus, in a case where the first determination unit 130 determines that the two arrangement order does not coincide with each other (No in S122), the output unit 140 outputs information indicating that two arrangement order does not coincide with each other, to the portable terminal held by a person in charge of a head office of the store or the person in charge of a manufacturer, or to a terminal installed in the store being a retail store (S124).

As described above, in the present example embodiment, it is possible to detect an error in a correspondence relation between a product and a shelf label, on the basis of a difference between the arrangement order of the product information and the arrangement order of the shelf label-product information, with high accuracy.

### Fourth Example Embodiment

[Functional Configuration]

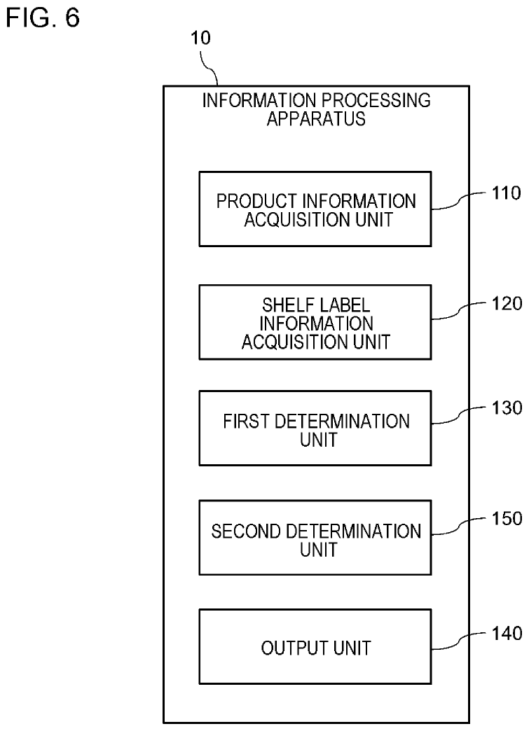

FIG. 6 is a block diagram illustrating a functional configuration of an information processing apparatus 10 according to a fourth example embodiment. The information processing apparatus 10 according to the present example embodiment has a functional configuration similar to the functional configuration of the information processing apparatus 10 according to the first to third example embodiments except that a second determination unit 150 (also serving as a third determination unit) is provided.

The second determination unit 150 determines whether or not a product to be surveyed is present in products recognized from an image to be processed. The product to be surveyed refers to, for example, a priority product of a retail store, a main product of the own manufacturer, and competitions of other manufacturers. The second determination unit 150 may determine whether or not the product to be surveyed is present in the image to be processed, using information for determining the product to be surveyed, for example, a product ID for uniquely identifying the product to be surveyed or the name of the product to be surveyed. The information for determining the product to be surveyed is stored in the memory 1060 or the storage device 1080 in advance, for example, by a preparation operation of inputting a list of the product to be surveyed in advance. In this case, the second determination unit 150 may acquire the information for determining the product to be surveyed from the memory 1060 or the storage device 1080. In addition, the second determination unit 150 may be configured to display the image to be processed on a display of the portable terminal of the person in charge of a retail store or the person in charge of a manufacturer and to cause the person in charge of the retail store or the person in charge of the manufacturer to select the product to be surveyed. In this case, the second determination unit 150 may acquire product information of a product selected on this image, as “the information for determining the product to be surveyed”.

[Hardware Configuration]

An information processing apparatus 10 in the present example embodiment has a hardware configuration (for example, FIG. 2) similar to the first example embodiment and the second example embodiment. In the present example embodiment, the storage device 1080 further stores a program module for implementing the function of the above-described second determination unit 150. The processor 1040 executes the program module, and thereby the function of the above-described second determination unit 150 is realized.

[Operation Examples]

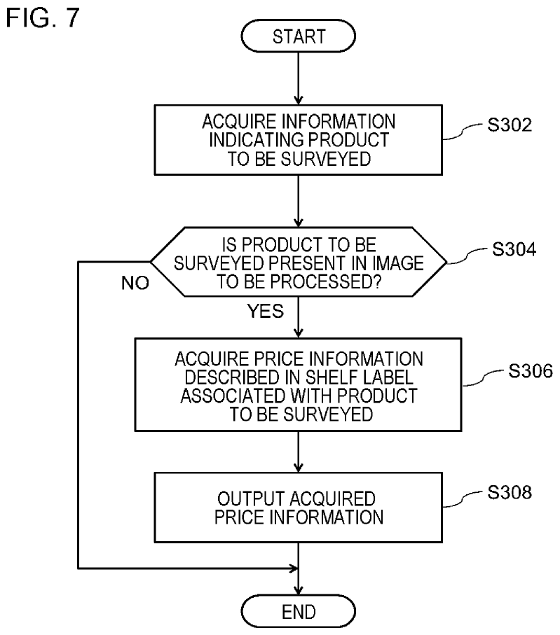

The information processing apparatus 10 according to the present example embodiment performs at least one of the above processing described in the first example embodiment and the above processing described in the second example embodiment, and also performs processing illustrated in FIG. 7. FIG. 7 is a flowchart illustrating an example of an operation of the information processing apparatus 10 according to the fourth example embodiment.

In the processing illustrated in FIG. 7, firstly, the second determination unit 150 acquires information (for example, at least one of product information and an image feature value) for determining a product to be surveyed (S302). For example, the second determination unit 150 may read product information of the product to be surveyed from a storage area of the memory 1060 or the storage device 1080. The second determination unit 150 determines whether or not the product to be surveyed is present in products recognized from the image to be processed, using the information for determining the product to be surveyed (S304). Specifically, in a case where the second determination unit 150 acquires the product information of the product to be surveyed acquired in S302, the second determination unit 150 collates the product information of the product to be surveyed with the product information acquired by the product information acquisition unit 110. In other words, the second determination unit 150 determines whether or not product information which coincides with the product information of the product to be surveyed is present in pieces of product information acquired by the product information acquisition unit 110. In a case where the product information which coincides with the product information of the product to be surveyed is present in the pieces of product information acquired by the product information acquisition unit 110 (YES in S304), the second determination unit 150 determines that the product to be surveyed is present in the image to be processed. In this case, the second determination unit 150 acquires price information described in a shelf label associated with the product determined as the product to be surveyed (S306). The price information acquired here is acquired from the shelf label-product information illustrated in FIG. 3 or 5, for example.

The output unit 140 outputs the price information acquired in the process of S306 (S308). For example, the output unit 140 may generate drawing data for displaying the price information acquired in the process of S306 in a state of being superimposed on the product determined as “the product to be surveyed”, on the basis of the image to be processed, and output the drawing data onto a display of a target terminal. In the above description, an example in which the second determination unit 150 is configured to acquire the information for determining the product to be surveyed is described. However, the example embodiment is not limited thereto. For example, in the following description, it is assumed that the output unit 140 outputs a recognition result (recognized product) obtained by recognition of the product information acquisition unit 110 onto a related display. The second determination unit 150 may determine whether or not the product to be surveyed is present in products recognized from the image to be processed, using the information of the product to be surveyed, in response to reception of an input operation (that is, operation of selecting the product to be surveyed) on a display of a user.

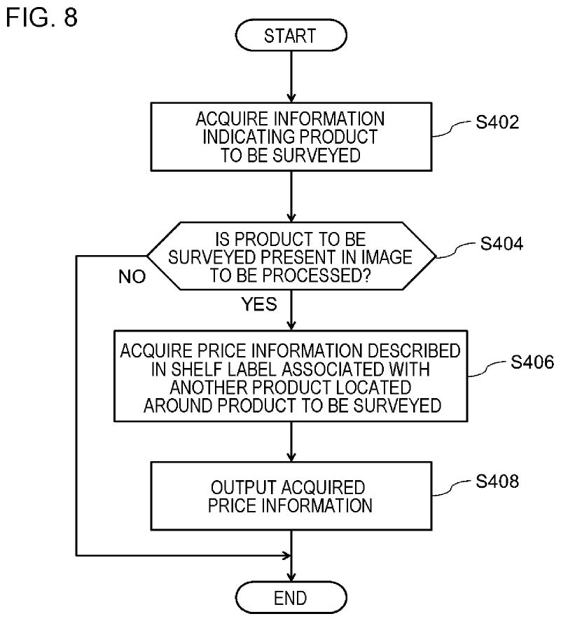

Further, the information processing apparatus 10 according to the present example embodiment may perform the processing illustrated in FIG. 8 instead or additionally. FIG. 8 is a flowchart illustrating another example of the operation of the information processing apparatus 10 according to the fourth example embodiment.

In the processing illustrated in FIG. 8, firstly, the second determination unit 150 acquires information (for example, at least one of product information and an image feature value) for determining a product to be surveyed (S402). For example, the second determination unit 150 may read product information of the product to be surveyed from a storage area of the memory 1060 or the storage device 1080. The second determination unit 150 determines whether or not the product to be surveyed is present in products recognized from the image to be processed, using the information for determining the product to be surveyed (S404). Specifically, in a case where the second determination unit 150 acquires the product information of the product to be surveyed acquired in S302, the second determination unit 150 collates the product information of the product to be surveyed with the product information acquired by the product information acquisition unit 110. In a case where the product information which coincides with the product information of the product to be surveyed is present in the pieces of product information acquired by the product information acquisition unit 110 (YES in S404), the second determination unit 150 determines that the product to be surveyed is present in the image to be processed. In this case, the second determination unit 150 determines another product located around the product to be surveyed and acquires price information described in a shelf label associated with the determined product (S406). The price information acquired here is acquired from the shelf label-product information illustrated in FIG. 3 or 5, for example, similar to the processing illustrated in FIG. 7.

The output unit 140 outputs the price information acquired in the process of S406 (S408). For example, the output unit 140 may generate drawing data for displaying the price information acquired in the process of S406 in a state of being superimposed on each product determined as “another product around the product to be surveyed”, on the basis of the image to be processed, and output the drawing data onto a display of a target terminal.

According to the present example embodiment, it is also possible to detect the error in the correspondence relation between a product and a shelf label with high accuracy. For example, in a case where the product to be surveyed is specified in advance, a holder of a terminal that receives information from the output unit 140 may easily recognize price information of the product to be surveyed or price information of a product around the product to be surveyed.

Hitherto, the example embodiments of the present invention are described with reference to the drawings, but the example embodiments are examples of the present invention. Various configurations other than the above description may be adopted.

In the plurality of flowcharts used in the above description, a plurality of steps (processes) are described in order. However, a performing order of the steps to be performed in the example embodiments is not limited to the order in the description. In the example embodiments, the order of the illustrated steps can be changed within a range without hindering the contents. Further, the above-described example embodiments can be combined in a range where the contents do not conflict with each other.

Some or all of the above example embodiments may be described as in the following supplementary notes, but are not limited to the followings.

1. An information processing apparatus including:

a product information acquisition unit that acquires a position of a product by analyzing an image in which the product and a shelf label are imaged;

a shelf label information acquisition unit that acquires a position of the shelf label by analyzing the image;

a first determination unit that determines consistency in a correspondence relation between the product and the shelf label on the basis of a relation between the acquired position of the product and the acquired position of the shelf label; and

an output unit that outputs a determination result of the consistency in the correspondence relation.

2. The information processing apparatus described in 1.,

in which the product information acquisition unit further acquires product information associated with the product by analyzing the image,

the shelf label information acquisition unit further acquires shelf label-product information described in the shelf label by analyzing the image, and

the first determination unit further determines the consistency in the correspondence relation between the product and the shelf label on the basis of a relation between the acquired product information and the acquired shelf label-product information.

3. The information processing apparatus described in 2.,

in which the output unit outputs at least one of a shift in the position of the shelf label, lack of the shelf label, a surplus of the shelf label, and an error in the shelf label-product information, as the determination result of the consistency in the correspondence relation.

4. The information processing apparatus described in any one of 1. to 3.,

in which the product information acquisition unit acquires a standard price associated with the product,

the shelf label information acquisition unit acquires a product price described in the shelf label, and

the first determination unit determines whether or not the product price described in the shelf label is within a price range of the standard price associated with the product.

5. The information processing apparatus described in any one of 1. to 4. further including:

a second determination unit that determines whether or not a product to be surveyed is present in products in the image;

in which, in a case where the product to be surveyed is present, the output unit further outputs a product price described in a shelf label corresponding to the product to be surveyed.

6. The information processing apparatus described in any one of 1. to 5. further including:

a third determination unit that determines whether or not a product to be surveyed is present in products in the image,

in which, in a case where the product to be surveyed is present, the output unit further outputs a product price described in a shelf label corresponding to another product present around the product to be surveyed.

7. The information processing apparatus described in any one of 2. to 6.,

in which the first determination unit determines whether or not an arrangement order of products based on the product information coincides with an arrangement order of the products based on the shelf label-product information.

8. An information processing method executed by a computer, the method including:

acquiring a position of a product by analyzing an image in which the product and a shelf label are imaged;

acquiring a position of the shelf label by analyzing the image;

determining consistency in a correspondence relation between the product and the shelf label on the basis of a relation between the acquired position of the product and the acquired position of the shelf label; and

outputting a determination result of the consistency in the correspondence relation.

9. The information processing method executed by a computer described in 8., the method further including:

acquiring product information associated with the product by analyzing the image;

acquiring shelf label-product information described in the shelf label by analyzing the image; and

determining the consistency in the correspondence relation between the product and the shelf label on the basis of a relation between the acquired product information and the acquired shelf label-product information.

10. The information processing method executed by a computer described in 9., the method further including:

outputting at least one of a shift in the position of the shelf label, lack of the shelf label, a surplus of the shelf label, and an error in the shelf label-product information, as the determination result of the consistency in the correspondence relation.

11. The information processing method executed by a computer described in any one of 8 to 10., the method further including:

acquiring a standard price associated with the product;

acquiring a product price described in the shelf label; and

determining whether or not the product price described in the shelf label is within a price range of the standard price associated with the product.

12. The information processing method executed by a computer described in any one of 8 to 11., the method further including:

determining whether or not a product to be surveyed is present in products in the image; and

in a case where the product to be surveyed is present, outputting a product price described in a shelf label corresponding to the product to be surveyed.

13. The information processing method executed by a computer described in any one of 8 to 12., the method further including:

determining whether or not a product to be surveyed is present in products in the image; and

in a case where the product to be surveyed is present, outputting a product price described in a shelf label corresponding to another product present around the product to be surveyed.

14. The information processing method executed by a computer described in any one of 9 to 13., the method further including:

determining whether or not an arrangement order of products based on the product information coincides with an arrangement order of the products based on the shelf label-product information.

15. A program causing a computer to perform the information processing method according to any one of 8. to 14.

This application claims priority based on Japanese Patent Application No. 2017-191791 filed on Sep. 29, 2017, the entire disclosure of which is incorporated herein.

1. An information processing apparatus comprising:
a product information acquisition unit that acquires a position of a product by analyzing an image in which the product and a shelf label are imaged;
a shelf label information acquisition unit that acquires a position of the shelf label by analyzing the image;
a first determination unit that determines consistency in a correspondence relation between the product and the shelf label on the basis of a relation between the acquired position of the product and the acquired position of the shelf label; and
an output unit that outputs a determination result of the consistency in the correspondence relation.

2. The information processing apparatus according to claim 1,
wherein the product information acquisition unit further acquires product information associated with the product by analyzing the image,
the shelf label information acquisition unit further acquires shelf label-product information described in the shelf label by analyzing the image, and
the first determination unit further determines the consistency in the correspondence relation between the product and the shelf label on the basis of a relation between the acquired product information and the acquired shelf label-product information.

3. The information processing apparatus according to claim 2,
wherein the output unit outputs at least one of a shift in the position of the shelf label, lack of the shelf label, a surplus of the shelf label, and an error in the shelf label-product information, as the determination result of the consistency in the correspondence relation.

4. The information processing apparatus according to claim 1,
wherein the product information acquisition unit acquires a standard price associated with the product,
the shelf label information acquisition unit acquires a product price described in the shelf label, and
the first determination unit determines whether or not the product price described in the shelf label is within a price range of the standard price associated with the product.

5. The information processing apparatus according to claim 1, further comprising:
a second determination unit that determines whether or not a product to be surveyed is present in products in the image,
wherein, in a case where the product to be surveyed is present, the output unit further outputs a product price described in a shelf label corresponding to the product to be surveyed.

6. The information processing apparatus according to claim 1, further comprising:
a third determination unit that determines whether or not a product to be surveyed is present in products in the image,
wherein, in a case where the product to be surveyed is present, the output unit further outputs a product price described in a shelf label corresponding to another product present around the product to be surveyed.

7. The information processing apparatus according to claim 2,
wherein the first determination unit determines whether or not an arrangement order of products based on the product information coincides with an arrangement order of the products based on the shelf label-product information.

8. An information processing method executed by a computer, the method comprising:
acquiring a position of a product by analyzing an image in which the product and a shelf label are imaged;
acquiring a position of the shelf label by analyzing the image;
determining consistency in a correspondence relation between the product and the shelf label on the basis of a relation between the acquired position of the product and the acquired position of the shelf label; and
outputting a determination result of the consistency in the correspondence relation.

9. The information processing method executed by a computer according to claim 8, the method further comprising:
acquiring product information associated with the product by analyzing the image;
acquiring shelf label-product information described in the shelf label by analyzing the image; and
determining the consistency in the correspondence relation between the product and the shelf label on the basis of a relation between the acquired product information and the acquired shelf label-product information.

10. The information processing method executed by a computer according to claim 9, the method further comprising:
outputting at least one of a shift in the position of the shelf label, lack of the shelf label, a surplus of the shelf label, and an error in the shelf label-product information, as the determination result of the consistency in the correspondence relation.

11. The information processing method executed by a computer according to claim 8, the method further comprising:
acquiring a standard price associated with the product;
acquiring a product price described in the shelf label; and
determining whether or not the product price described in the shelf label is within a price range of the standard price associated with the product.

12. The information processing method executed by a computer according to claim 8, the method further comprising:
determining whether or not a product to be surveyed is present in products in the image; and
in a case where the product to be surveyed is present, outputting a product price described in a shelf label corresponding to the product to be surveyed.

13. The information processing method executed by a computer according to claim 8, the method further comprising:
determining whether or not a product to be surveyed is present in products in the image; and
in a case where the product to be surveyed is present, outputting a product price described in a shelf label corresponding to another product present around the product to be surveyed.

14. The information processing method executed by a computer according to claim 9, the method further comprising:
determining whether or not an arrangement order of products based on the product information coincides with an arrangement order of the products based on the shelf label-product information.

15. A non-transitory computer readable medium storing a program causing a computer to perform an information processing method, the method comprising:
acquiring a position of a product by analyzing an image in which the product and a shelf label are imaged;
acquiring a position of the shelf label by analyzing the image;
determining consistency in a correspondence relation between the product and the shelf label on the basis of a relation between the acquired position of the product and the acquired position of the shelf label; and
outputting a determination result of the consistency in the correspondence relation.
